(19) United States
(12) Patent Application Publication
(10) Pub. No.: US 2007/0041361 A1
(43) Pub. Date: Feb. 22, 2007

(54) Apparatus and methods for implementing an in-call voice user interface using context information

(75) Inventor: Juha Iso-Sipila, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/204,689

(22) Filed: Aug. 15, 2005

(51) Int. Cl. H04L 12/66

(52) U.S. Cl. 370/352

(57) ABSTRACT

The present invention concerns methods and apparatus for performing voice-controlled actions during an ongoing voice telephony session. In particular, the methods and apparatus of the present invention provide a voice-operated user interface to perform actions during an ongoing voice telephony session. Many of the actions that can be performed during the ongoing voice telephony session are context-sensitive and relate to the context of the telephone call. In addition, context information relating to the ongoing voice telephony session can be used to greatly simplify both the operation of the voice-controlled user interface and the programming of actions requested using the voice-controlled interface.

### TECHNICAL FIELD

The present invention generally concerns methods and apparatus for implementing voice control over operations performed with a portable communications device and more particularly concerns methods and apparatus for implementing a voice-controlled user interface for performing operations during an ongoing communications session.

### BACKGROUND

In handheld portable communications devices there have been developments providing the ability to perform in-call actions. Heretofore, these actions have been implemented through a graphical user interface and keypad (or other button-operated or touch-sensitive) controls. Although users appreciate the ability to perform actions during an ongoing voice communications session, there have been problems encountered in such modes of operation.

In particular, most users need to be able to see the graphical user interface and keypad (or other buttons) in order to accurately control the operations necessary to perform an action. This requires the user to remove the hand-held portable communications device from a position adjacent to the user's ear and mouth. In order to perform such operations it is necessary to interrupt the voice communications session. Once the operations necessary to program the action have been performed, the user needs to return the portable communications device to a position adjacent to the user's ear and mouth, while at the same time selecting a key to return the user to the ongoing voice telephony session (which typically has been “on hold” during the pendency of the programming of the in-call action). The operations necessary to program the hand-held portable communications device during an ongoing voice telephony session are therefore often balky and inconvenient. It is not unusual for the other party to the voice telephony session to be confused whether the session is continuing or whether it has been lost.

Further, similar problems can occur in situations where a user is utilizing a headset. In certain situations, a headset may be even more inconvenient for a user. Often, a user of such a headset has the portable communications device securely attached to, for example, a belt-mounted holster. In such situations, it is necessary for the user to remove the portable communications device from the holster in order to enter the keystrokes necessary to perform the action desired by the user. If the voice telephony session is being controlled, in part, using controls mounted on an extension to a wired headset the situation may be even more inconvenient for a user, since the user has to fumble between two sets of controls.

Thus, users of such portable communications devices desire modes of control that are more convenient. In particular, those using a portable communications device without a headset desire modes of control that do not require the user to remove the portable communications device from a position adjacent to the user's mouth and ear during a voice telephony session. Those using a portable communications device with a headset desire modes of control that do not require the user to remove the portable communications device from a holster in order to program the portable communications device to perform the desired action.

In addition, assuming the availability of an improved user interface to program actions that can be performed during ongoing voice telephony session, users would desire that such a user interface operate in as simple a manner as possible. In particular, users would desire that it employ information that is readily available to the portable communications device to simplify the programming of an action using the voice controlled user interface.

### SUMMARY OF THE PREFERRED EMBODIMENTS

The foregoing and other problems are overcome, and other advantages are realized, in accordance with the following embodiments of the present invention.

A first embodiment of the present invention comprises a memory medium for storing a computer program executable by a digital processor of a portable communications device, where the computer program performs operations during a voice telephony session occurring between a user of the portable communications device and another party, where the operations comprise: during the ongoing voice telephony session, receiving an access command to access a voice-controlled user interface; receiving at least one voice command to perform an action during the ongoing voice telephony session, where the at least one voice command is entered using the voice-controlled user interface; and performing the action.

A second embodiment of the present invention comprises a portable communication device with voice telephony capability, the portable communications device comprising: a memory for storing at least one computer program, where the at least one computer program performs operations during a voice telephony session occurring between a user of the portable communications device and another party; a digital processor, where the digital processor performs the following operations when the at least one computer program is executed: during the ongoing voice telephony session, receiving an access command to access a voice-controlled user interface; receiving at least one voice command to perform an action during the ongoing voice telephony session, where the at least one voice command is entered using the voice-controlled user interface; and performing the action.

A third embodiment of the present invention comprises a method for use in a portable communications device having a voice-controlled user interface, the method comprising: receiving an access command to access the voice-controlled user interface during an ongoing voice communications session occurring between a user of the portable communications device and another party; receiving at least one voice command to perform an action during the ongoing voice telephony session, where the at least one voice command is entered using the voice-controlled user interface; and performing the action.

A fourth embodiment of the present invention comprises a mobile station for use in a telecommunications network, the mobile station comprising: a memory for storing an operating program for controlling the mobile station, where the operating program further comprises a computer program component, where the computer program component performs operations to provide and to control a voice-controlled user interface operable during a voice telephony session occurring between a user of the mobile station and another party; a wireless section comprising a digital signal processor; a wireless transceiver; and an antenna; a microphone for receiving voice information; a speaker for conveying at least voice responses and voice-controlled user interface responses; and a processing unit coupled to the memory, wireless section, microphone and speaker, whereby when the computer program component is executed by the processing unit the following operations are performed: receiving an access command to access the voice-controlled user interface during an ongoing voice communications session occurring between a user of the portable communications device and another party; receiving at least one voice command to perform an action during the ongoing voice telephony session, where the at least one voice command is entered using the voice-controlled user interface; and performing the action.

A fifth embodiment of the present invention comprises a mobile station for use in a telecommunications network, the mobile station comprising: memory means for storing an operating program for controlling the mobile station, where the operating program further comprises a computer program component, where the computer program component performs operations to provide and to control a voice-controlled user interface operable during a voice telephony session occurring between a user of the mobile station and another party; wireless section means comprising digital signal processing means; wireless transceiver means; and antenna means, the wireless section means for performing wireless communications operations; microphone means for receiving voice information and voice-controlled user interface commands; speaker means for conveying at least voice responses and voice-controlled user interface responses; and processor means coupled to the memory means, wireless section means, microphone means and speaker means, whereby when the computer program component is executed by the processing means the following operations are performed: receiving an access command to access the voice-controlled user interface during an ongoing voice communications session occurring between a user of the portable communications device and another party; receiving at least one voice command to perform an action during the ongoing voice telephony session, where the at least one voice command is entered using the voice-controlled user interface; and performing the action.

Thus it is seen that the foregoing embodiments of the present invention overcome the limitations of the prior art. In particular, in devices operating in accordance with the prior art it is difficult to access an in-call user interface, since such interfaces are typically button-controlled. For example, in portable communications devices having button-controlled in-call graphical user interfaces it is usually necessary for a user to remove the handset from a position where voice telephony can occur so that the user can operate the buttons of the in-call graphical user interface.

In contrast, in methods and apparatus of the present invention, an in-call voice-controlled user interface is provided. In embodiments of the present invention the user can easily transition between voice communication sessions and voice-controlled user interface sessions to program in-call actions without moving the portable communications device. This is achieved because the same instrumentalities are used by the voice-operated user interface and voice telephony sessions. In particular, the possibility of losing a voice communication session is substantially reduced since the user need not fumble between different sets of controls. Further, the use of contextual information related to the ongoing voice communication session to simplify the programming of certain in-call actions makes it easier to use these modes of operation.

In conclusion, the foregoing summary of the embodiments of the present invention is exemplary and non-limiting. For example, one skilled in the art will understand that one or more aspects or steps from one embodiment can be combined with one or more aspects or steps from another embodiment of the present invention to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts a wireless communications system in which the methods of the present invention can be practiced;

FIGS. 2A-2B depict conventional portable communications devices having button- and graphical-user-interface operated controls;

FIGS. 3A-3B depict portable communications devices capable of operating in accordance with the present invention;

FIG. 4 is a flow chart depicting a method operating in accordance with the present invention; and

FIG. 5 is a flow chart depicting options available in performing the method depicted in FIG. 1.

### DETAILED DESCRIPTION OF THE PREFERRED EMBODIMENTS

The methods and apparatus of the present invention can be practiced in a portable communications device—such as, for example, a wireless cellular telephone—operable in a wireless communications system. Details associated with a wireless cellular telephone and wireless communications system will be described first as background, followed by a description of the prior art, and then by a description of various embodiments of the invention.

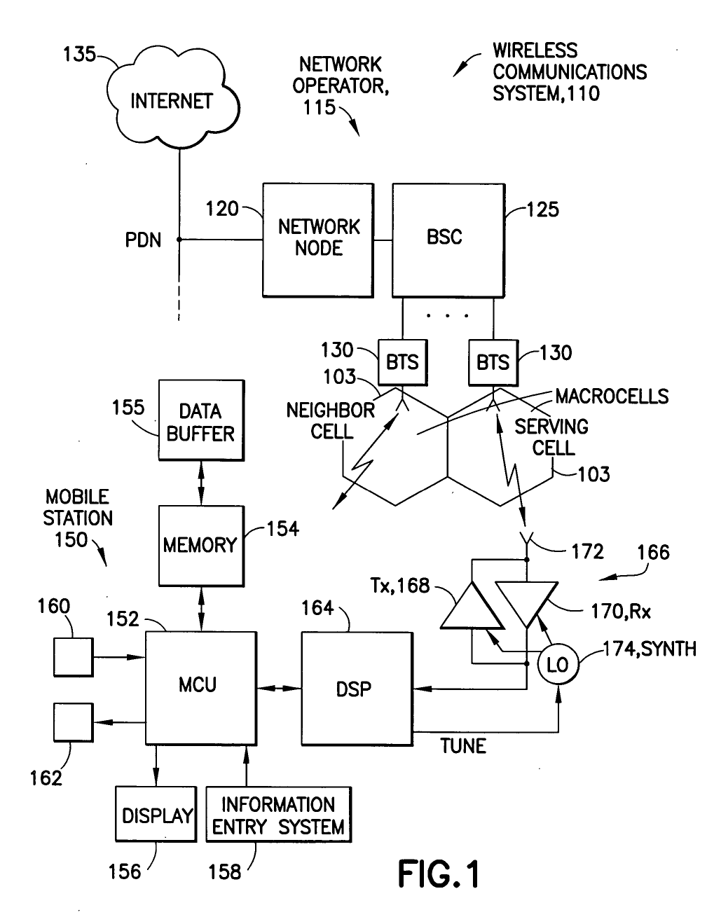

FIG. 1 depicts in simplified form a block diagram of a wireless communications system 110 in which a mobile station 150 operates. “Mobile station” herein is used interchangeably with “portable communications device” and generally covers any wireless device with voice telephony capability. Also shown is an exemplary network operator 115 having, for example, a network node 120 for connecting to a telecommunications network, such as a Public Packet Data Network or PDN; at least one base station controller (BSC) 125 or equivalent apparatus; and a plurality of base transceiver stations (BTS) 130, also referred to as base stations (BSs), that transmit in a forward or downlink direction both physical and logical channels to the mobile station 150 in accordance with a predetermined air interface standard. A reverse or uplink communications path also exists from the mobile station 150 to the network operator 115, which conveys mobile-station-originated access requests and traffic. A cell 103 is associated with each BTS 130, where one cell will at any given time be considered to be a serving cell, while an adjacent cell(s) will be considered to be a neighbor cell. Smaller cells (e.g., picocells) may also be available.

The air interface standard can conform to any suitable standard or protocol, and may enable both voice and data traffic, such as data-traffic-enabling Internet 135 access and web page downloads. In the embodiment depicted in FIG. 1 the air interface standard is compatible with a code division multiple access (CDMA) air interface standard, such as CDMA2000, although the particular air interface standard used by the wireless communication system is not a limitation upon the practice of this invention.

The mobile station 150 typically includes a control unit or control logic, such as a microcontrol unit (MCU) 152 (a data processor) having an output coupled to an input of a display 156 and an input coupled to an output of an information entry system 158. The information entry system can comprise voice-activated information entry systems; touch-initiated information entry systems such as, for example, keyboards, keypads or touch screens; and combinations thereof. For example, a touch-initiated information entry system can be combined with a voice-activated information entry system in various embodiments. A microphone 160 and speaker 162 are typically provided for enabling the user to conduct voice calls in a conventional manner.

The mobile station 150 could also be contained within a card or module that is connected during use to another device. For example, the mobile station 10 could be contained within a PCMCIA or similar type of card or module that is installed during use within a portable data processor, such as a laptop or notebook computer, or even a computed that is wearable by a user.

The MCU 152 is assumed to include or be coupled to some type of memory 154, including a non-volatile memory for storing an operating program and other information, as well as a volatile memory for temporarily storing required data, scratchpad memory, received packet data, packet data to be transmitted, and the like. At least some of this temporary data can be stored in a data buffer 155. The operating system is assumed, for the purposes of this invention, to enable the MCU 152 to execute the software routines, layers and protocols required to implement the methods in accordance with this invention, as well as to provide a suitable voice-controlled user interface (UI), via microphone 160 and speaker 162, for a user.

The mobile station 150 also contains a wireless section that includes a digital signal processor (DSP) 164, or equivalent high speed processor or logic, as well as a wireless transceiver 166 that includes a transmitter 168 and a receiver 170, both of which are coupled to an antenna 172 for communication with the network operator. At least one local oscillator, such as a frequency synthesizer (SYNTH) 174, is provided for tuning the transceiver. Data, such as digitized voice and packet data, is transmitted and received through antenna 172.

The preceding description concerned one possible environment in which a portable communications device made in accordance with the present invention may operate. Now more detailed aspects of both the prior art and the invention will be presented.

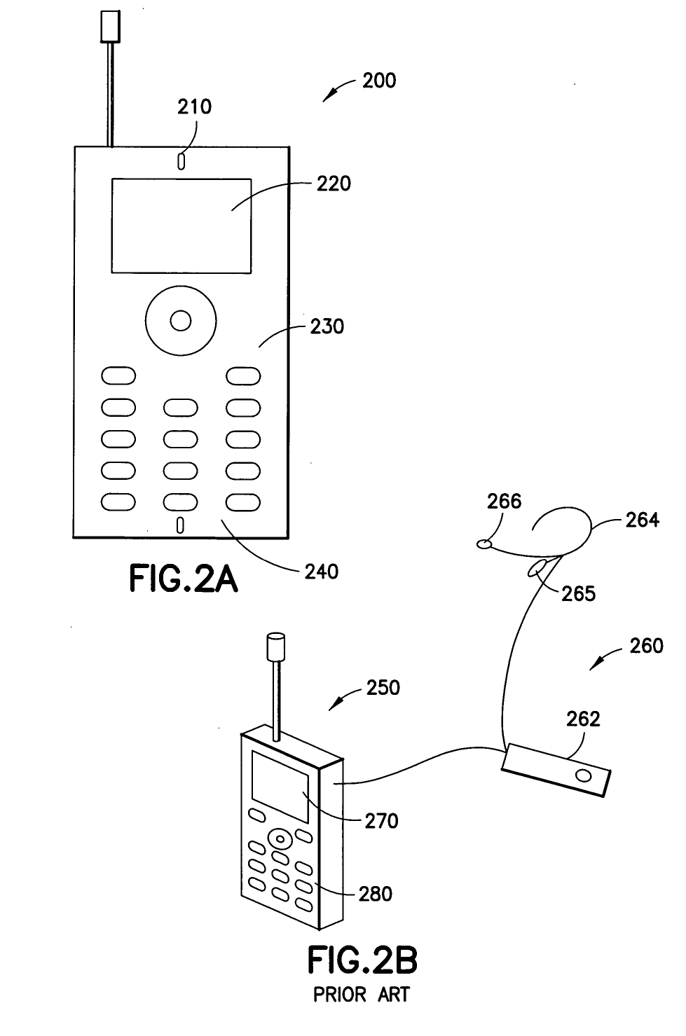

FIGS. 2A and 2B depict portable communications devices 200 and 250 capable of operating in accordance with the prior art. The portable communications device 200 such as, for example, a wireless cellular telephone, has a speaker 210; a display 220; a keypad 230 with a plurality of buttons; and a microphone 240. Some progress has been made in implementing the ability to perform actions during an ongoing voice communications session. However, in conventional devices like that depicted in FIG. 2A the actions are typically programmed using both a graphical user interface shown on display 220 and the keypad 230. Contemplation of how an action would be programmed during an ongoing voice communication session with a device like that depicted in FIG. 2A reveals the problematic nature of programming in-call actions using the display 220 and keypad 230.

In typical use, the portable communications device 200 would be held near to a user's cheek between the user's ear and mouth during an ongoing voice communications session. In order to program the desired action, the user would have to remove the portable communications device 200 from a position where voice communication can be transacted (the cheek position) to a position where the display 220 can be seen and the keypad 230 manipulated. Since the ongoing voice communications session would need to be interrupted while an action is being programmed with the display 220 and keypad 230, this necessity introduces the possibility of a lost call or other inconvenience, especially when the other party to the communications session is unfamiliar with these modes of operation. For example, while an action is being programmed, the other party may mistakenly conclude that the voice communication session has ended and terminate the call.

The portable communications device 250 depicted in FIG. 2B presents similar and possibly even more problematic modes of operation. As is apparent, the portable communications device 250 has a detachable wired headset 260. The wired headset 260 is comprised of a hand-operated control 262 with an earpiece 264 having a speaker 265 and microphone 266. Typically, during normal operation, the portable communications device 250 would be mounted in a belt holster, and call initiation and termination would be handled with the hand-operated control 262. In-call actions, however, may require the user to remove the portable communications device 250 from the holster so that the display 270 can be viewed and the keypad 280 manipulated for programming the action. This may require the user to fumble back and forth between the hand-operated control 262 and the keypad 280.

These problems have been overcome in embodiments of the present invention through an in-call voice-controlled user interface. In contrast to the keypad and display control of the prior art, the user need not move the portable communications device from a position adjacent to the user's cheek or, in the case where the user has a headset, from a holster. Instead, through the use of a single easily-accessible button, a user can enter the voice-operated user interface. In other embodiments of the present invention a voice key may be used to access the voice-controlled user interface. Since the voice-operated user interface preferably uses the same instrumentality as that used for the voice communications session, there is no need to move the portable communications device from its voice communications session position. In addition, the ability to use contextual information relating to the ongoing voice communications session provides additional improvements over the prior art.

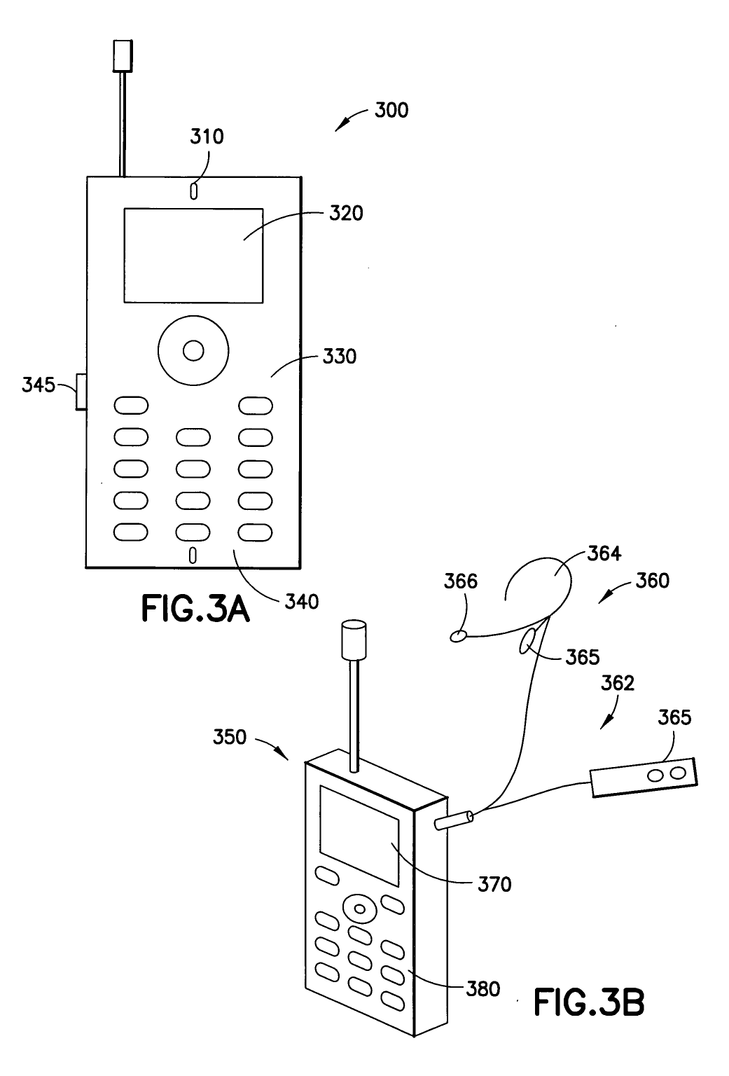

Portable communications devices 300, 350 capable of operating in accordance with embodiments of the invention are depicted in FIGS. 3A-3B. Portable communications device 300 comprises a speaker 310; a display 320; a keypad 330; and a microphone 340. In addition, portable communications device 300 further comprises an easily-accessible button 345 to activate the voice user interface during a voice communication session. In contrast to the graphical user interface and keypad instrumentalities described in reference to prior art device 200, a user need only depress button 345 to access the voice user interface. The button 345 can be easily accessed during a voice communications session without moving the portable communications device 300. As stated previously, in alternate embodiments the voice-controlled user interface may be accessed with a voice key. Since voice telephony and the voice-controlled user interface use the same instrumentalities (such as, for example, speaker 310 and microphone 340) there is no need to move the portable communications device from a position where voice communications sessions are possible. This means there is less of a likelihood of a lost call as the user transitions from a voice communications session to a voice-operated user interface session and back again.

Similar novel modes of operation are possible with the portable communications device 350 depicted in FIG. 3B. The portable communications device 350 depicted in FIG. 3B comprises a display 370, keypad 380 and a wired headset 360 with associated hand-operated control module 362. The wired headset 360 further comprises an ear piece 364 with speaker 365 and a mouthpiece with microphone 366. The hand-operated control module 362 associated with the wired headset 360 further comprises a button 365 for accessing the voice-operated user interface. As in the case of the embodiment depicted in FIG. 3A, there is no need for the user to move the portable communications device 350 when transitioning from a voice communications session to a voice-controlled user interface session. Since voice communications and the voice-controlled user interface use the same instrumentalities (such as, for example, the speaker and microphone mounted in the headset 360) there is no need to access the display 370 and keypad 380 of the portable communications device 350 to program an in-call action.

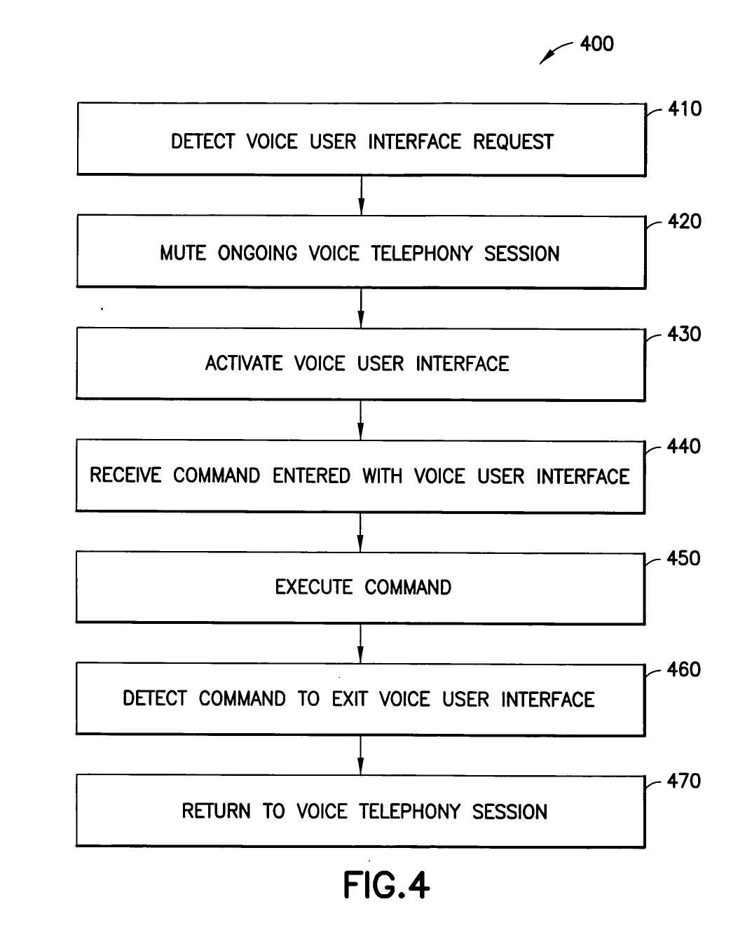

Now a more detailed description of the methods of the present invention will be presented. FIG. 4 is a flowchart depicting a method 400 operating in accordance with the present invention. At step 410, a computer program being executed by the portable communications device detects a voice user interface request. Next, at step 420, the computer program mutes the ongoing voice telephony session. Then, at step 430, the computer program activates the voice-controlled user interface. Next, at step 440, a microphone of the portable communications device receives a command entered with the voice user interface. Then, at step 450, the portable communications device executes the command entered using the voice controlled user interface. Next, at step 460, the computer program detects a command to exit the voice user interface. Then, at step 470, the computer program returns the portable communications device to the voice telephony session. In alternate embodiments of the invention a separate command need not be entered to end the voice-controlled user interface session. Instead, a time-out procedure would be used; after the passage of a predetermined time interval without entry of additional voice commands the voice-controlled user interface would return the user to the ongoing voice communications session.

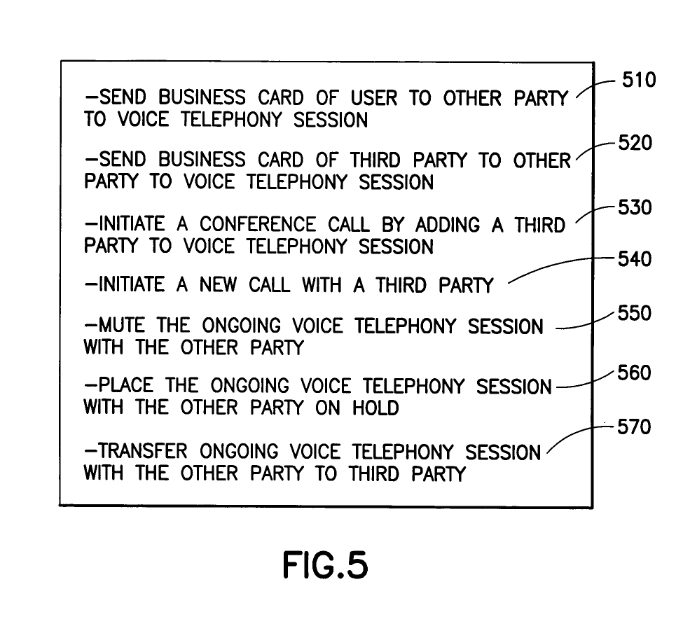

FIG. 5 depicts various actions that can be programmed using the voice-controlled user interface. In an action depicted at 510, a business card of the user would be sent to the other party to the voice telephony session. In this action, the user would say “Send business card” while in an ongoing voice-activated user interface session. No information would have to be input during the voice-activated user interface session besides the command because programming implementing the voice-activated user interface would use context information associated with the ongoing telephone call (e.g., an internet address associated with the telephone number of the other party to the ongoing telephone session) to perform the programmed action.

In another action depicted at 520, a business card of a third party would be sent by the user of the voice-controlled user interface to the other party to the voice telephony session by entering a voice command (e.g., “Send business card of John Smith”). As in the case 510 where the user commanded that her own business card be sent to the other party to the ongoing voice communications session, the software implementing the action programmed using the voice-controlled user interface would use context information associated with the ongoing voice communication session to perform the programmed action.

In a further action 530, a conference call would be initiated by adding a third party to the ongoing voice telephony session. In one possible embodiment of the present invention, a voice command to begin such a session would be, for example, “Group Call John Smith.”

In a yet another action 540, the user would initiate another voice telephony session by speaking a command such as, for example, “New Call John Smith” while the original voice telephony session is on hold. In a still further example at 550, the ongoing voice telephony session would be muted by speaking a command “Mute call”. In another action depicted at 560, the other party to the voice telephony session would be placed on hold by speaking a command “Call on hold”. In a further action depicted at 570, the ongoing voice telephony session would be transferred to a third party by the user of the voice-controlled user interface by speaking a command such as, for example, “Divert to John Smith.”

A particular advantage of the present invention is that it can use contextual information related to the on-going voice communications session to perform an action. For example, as discussed in the preceding examples, in methods of the present invention information associated with the name or telephone number of the other party to the voice communications session is used to perform the action programmed during the voice-controlled user interface session. This ability to use contextual information can simplify the programming of actions with the voice-controlled user interface. In particular, the use of contextual information greatly simplifies the information that need be entered by a user to program an action. In various situations, the name of the other party to the ongoing voice telephony session can be used both in the voice-controlled user interface (by a voice synthesizer used to present options available to the user of the voice-controlled user interface) or in the performance of an action after it has been programmed by a user. In the latter example, internet address information associated with a name can be used to send, for example, an electronic business card to the other party to the ongoing voice telephony session.

One of ordinary skill in the art will understand that the methods depicted and described herein can be embodied in a tangible computer-readable memory medium. Instructions embodied in the tangible computer-readable memory medium perform the steps of the method when executed. Tangible computer-readable memory media include, but are not limited to, hard drives, CD- or DVD-ROM, flash memory storage devices or in a RAM memory of a computer system.

Thus it is seen that the foregoing description has provided by way of exemplary and non-limiting examples a full and informative description of the best methods and apparatus presently contemplated by the inventors for implementing an in-call voice user interface using context information. One skilled in the art will appreciate that the various embodiments described herein can be practiced individually; in combination with one or more other embodiments described herein; or in combination with voice-controlled user interfaces differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

What is claimed is:

1. A memory medium for storing a computer program executable by a digital processor of a portable communications device, where the computer program performs operations during a voice telephony session occurring between a user of the portable communications device and another party, where the operations comprise:
during the ongoing voice telephony session,
receiving an access command to access a voice-controlled user interface;
receiving at least one voice command to perform an action during the ongoing voice telephony session, where the at least one voice command is entered using the voice-controlled user interface; and
performing the action.

2. The memory medium of claim 1 where the access command is entered using a button of the portable communications device.

3. The memory medium of claim 1 where the access command comprises a voice access command entered using a microphone of the portable communications device.

4. The memory medium of claim 1 where context information associated with the voice telephony session is used in the voice-controlled user interface.

5. The memory medium of claim 4 where the context information comprises a name of the other party to the ongoing voice telephony session.

6. The memory medium of claim 1 where context information associated with the ongoing voice telephony session is used in performing the action programmed using the at least one voice command.

7. The memory medium of claim 6 where the context information comprises a name of the other party to the ongoing voice telephony session.

8. The memory medium of claim 6 where the context information comprises a telephone number of the other party to the ongoing voice telephony session.

9. The memory medium of claim 6 where the context information comprises an e-mail address associated with the other party to the ongoing voice telephony session.

10. The memory medium of claim 1 where the at least one voice command to perform an action further comprises a plurality of voice commands which together specify the action to be performed during the ongoing voice telephony session.

11. The memory medium of claim 1 where the operations further comprise:
after receiving the access command to access the voice-controlled user interface, and prior to receiving the at least one voice command to perform an action, muting the voice telephony session.

12. The memory medium of claim 1 where the action is related to a context of the voice telephony session.

13. The memory medium of claim 1 where the action comprises sending a business card of the user to the other party to the ongoing voice telephony session.

14. The memory medium of claim 1 where the action comprises sending a business card of a third party to the other party to the ongoing voice telephony session.

15. The memory medium of claim 1 where the action comprises initiating a conference call.

16. The memory medium of claim 1 where the action comprises placing the other party to the ongoing voice telephony session on hold.

17. The memory medium of claim 1 where the action comprises initiating a new voice telephony session with a third party during the ongoing voice telephony session.

18. The memory medium of claim 1 where the action comprises muting the ongoing voice telephony session.

19. The memory medium of claim 1 where the action comprises forwarding the ongoing voice telephony session to a third party.

20. A portable communication device with voice telephony capability, the portable communications device comprising:
a memory for storing at least one computer program, where the at least one computer program performs operations during a voice telephony session occurring between a user of the portable communications device and another party;
a digital processor, where the digital processor performs the following operations when the at least one computer program is executed:
during the ongoing voice telephony session,
receiving an access command to access a voice-controlled user interface;
receiving at least one voice command to perform an action during the ongoing voice telephony session, where the at least one voice command is entered using the voice-controlled user interface; and
performing the action.

21. The portable communications device of claim 20 where context information associated with the ongoing voice telephony session is used in performing the action programmed using the at least one voice command.

22. A method for use in a portable communications device having a voice-controlled user interface, the method comprising:
receiving an access command to access the voice-controlled user interface during an ongoing voice communications session occurring between a user of the portable communications device and another party;
receiving at least one voice command to perform an action during the ongoing voice telephony session, where the at least one voice command is entered using the voice-controlled user interface; and
performing the action.

23. The method of claim 22 wherein context information associated with the ongoing voice communications session is used in performing the action programmed using the at least one voice command.

24. A mobile station for use in a telecommunications network, the mobile station comprising:
a memory for storing an operating program for controlling the mobile station, where the operating program further comprises a computer program component, where the computer program component performs operations to provide a voice-controlled user interface operable during a voice telephony session occurring between a user of the mobile station and another party;
a wireless section comprising a digital signal processor; a wireless transceiver;
and an antenna;
a microphone for receiving voice information;
a speaker for conveying at least voice and voice-controlled user interface responses; and
a processing unit coupled to the memory, wireless section, microphone and speaker, whereby when the computer program component is executed by the processing unit the following operations are performed:
receiving an access command to access the voice-controlled user interface during an ongoing voice communications session occurring between a user of the portable communications device and another party;
receiving at least one voice command to perform an action during the ongoing voice telephony session, where the at least one voice command is entered using the voice-controlled user interface; and
performing the action.

25. The mobile station of claim 24 wherein context information associated with the ongoing voice communication session is used in performing the action programmed using the at least one voice command.

26. A mobile station for use in a telecommunications network, the mobile station comprising:
memory means for storing an operating program for controlling the mobile station, where the operating program further comprises a computer program component, where the computer program component performs operations to provide and to control a voice-controlled user interface operable during a voice telephony session occurring between a user of the mobile station and another party;
wireless section means comprising digital signal processing means; wireless transceiver means; and antenna means, the wireless section means for performing wireless communications operations;
microphone means for receiving voice information and voice-controlled user interface commands;
speaker means for conveying at least voice and voice-controlled user interface responses; and
processor means coupled to the memory means, wireless section means, microphone means and speaker means, whereby when the computer program component is executed by the processing means the following operations are performed:
receiving an access command to access the voice-controlled user interface during an ongoing voice communications session occurring between a user of the portable communications device and another party;
receiving at least one voice command to perform an action during the ongoing voice telephony session, where the at least one voice command is entered using the voice-controlled user interface; and
performing the action.

27. The mobile station of claim 26 wherein context information associated with the ongoing voice communications session is used in performing the action programmed using the at least one voice command.
